(19) United States
(12) Patent Application Publication
(10) Pub. No.: US 2019/0339028 A1
(43) Pub. Date: Nov. 7, 2019

(54) FLUID INLET-OUTLET MANIFOLD

(71) Applicant: AKWEL, Champfromier (FR)

(72) Inventors: Joaquim FERNANDES, Mazan (FR); Jérémy DREUX, Meriel (FR); Stéphane SANDA, Malemort du Comtat (FR)

(73) Assignee: AKWEL, Champfromier (FR)

(21) Appl. No.: 16/400,103

(22) Filed: May 1, 2019

(30) Foreign Application Priority Data
May 2, 2018 (FR) 18/70495
Sep. 13, 2018 (FR) 18/71035

(51) Int. Cl. F28F 9/06; F28F 9/02; H01M 10/613; H01M 10/625; H01M 10/6568

(52) U.S. Cl. CPC F28F 9/06; F28F 9/0243; H01M 10/613; H01M 2220/20; H01M 10/6568; F28F 2280/02; H01M 10/625

(57) ABSTRACT

The manifold includes a column provided according to a longitudinal axis with a plurality of fluid outlet orifices spaced apart from each other. The column is removably mounted from a plurality of modular sections, each column section being provided with at least one female tubular axial fitting and/or with at least one male tubular axial fitting and featuring a radial opening delimiting the outlet orifice. Furthermore, a male tubular fitting is adapted to nest into and slide in a tight manner inside a female tubular fitting to enable a translational displacement of the sections relative to each other in directions of extension and retraction of the manifold in order to vary the spacing between two outlet orifices.

### TECHNICAL FIELD

The present invention concerns a manifold for distributing or collecting a fluid towards or coming from a fluid circulation network, for example a thermal regulation circuit of a battery-pack or of a battery of an electric and/or hybrid motor vehicle.

The thermal regulation of the battery, in particular in the field of electric and hybrid vehicles, is a crucial aspect to the operation thereof. Indeed, the temperature of the battery must remain comprised between 20° C. and 40° C. in order to ensure the reliability, the autonomy and the performance of the vehicle and to optimize the service life of the battery.

### STATE OF THE ART

In electric and hybrid vehicles, the battery generally comprises several electrical energy storage cells connected to each other so as to create an electric generator with desired voltage and capacity. These electrical energy storage cells positioned in a protective case form what is called a battery-pack.

In general, the thermal regulation is ensured by means of a heat-transfer fluid which circulates in a heat exchanger positioned in contact with the battery and traversed by the heat-transfer fluid according to a more or less complex fluid circulation pathway.

Thus, the heat-transfer fluid can absorb the heat emitted by each battery in order to cool them or, where the need may be, it can bring in heat if the temperature of the battery is not sufficient, for its proper operation.

The thermal regulation of such a battery-pack is generally achieved by multiple fluid circulation tubular channels disposed in series or in parallel passing as close as possible to the cells of the battery. Thus, this fluidic network achieves a tight coverage of the entire surface of the battery to form an effective heat exchange area.

These channels are generally connected to each other at an inlet and a common outlet by a longitudinal fluid inlet-outlet manifold.

In the case of channels disposed with a tight step, such a manifold is generally monolithic, has a low dimensional flexibility and consequently it can hardly compensate variations in the axes' spacings between the channels or a possible misalignment of the channels. In order to make them more flexible, these manifolds may terminate in an elastomer or thermoplastic hose

Such a design requires producing a new manifold part for each new heat exchanger configuration (number of channels, spacings between the axes of the channels, etc.). Thus, the design is voluminous and expensive.

Another known solution of the prior art consists in connecting the channels by short flexible connection hoses mounted on a T-shaped branch connector at the end of each channel of the fluidic network. Hence, this solution offers a large flexibility in axes' spacing variation between the channels and can be applied to any heat exchanger configuration. Nonetheless, this solution has a limitation when the step between the channels is too short. In this case, it is difficult to sufficiently bend the short hose to engage it between the two channels of the network.

### SUMMARY OF THE INVENTION

The present invention aims at improving the solutions proposed in the state of the art and at solving at least partially the drawbacks exposed hereinabove. The invention aims at finding a solution for flexible connection of several «manifold» type channels which can compensate considerable tolerances between the channels. This simplification also allows considerably reducing the manufacturing cost of the manifold while proposing a product which can adapt to several spacings between the channels' axes.

The invention consists in compensating the possible misalignments of the channels enabling mounting of the parts and avoiding the transverse constraints on the channels/manifold connections.

To this end, an object of the invention is a fluid inlet-outlet manifold comprising a column provided according to a longitudinal axis with a plurality of fluid flow orifices spaced apart from each other, characterized in that the column is removably mounted from a plurality of modular sections, each column section being provided with at least one female tubular axial fitting and/or with at least one male tubular axial fitting and featuring one single radial opening delimiting the flow orifice and in that a male tubular fitting is adapted to nest into and slide in a tight manner inside a consecutive female tubular fitting to enable a translational displacement of the sections relative to each other in directions of extension and retraction of the manifold in order to vary the spacing between two flow orifices.

This solution is very compact and allows connecting channels of a fluid circulation network with short inter-channels axes' spacings and adapts to the dimensional dispersions of the inter-channels axes' spacings.

Moreover, in order to enlarge the length of the manifold, all it needs is to increase the number of modular sections which allows increasing the number of pathways on the manifold.

An inlet-outlet manifold according to the invention may include one or more of the following features.

In a preferred embodiment of the invention, the male fitting has a reduced external diameter compared to the external diameter of the female fitting.

In a preferred embodiment of the invention, the column section comprises a radially-extending tubular connector body which delimits a fluid flow passage featuring a free end forming the flow orifice.

In a preferred embodiment of the invention, the connector body forms a portion of a quick-coupling connector.

In a preferred embodiment of the invention, the column comprises at least one column section called central section configured to be connected to two other sections, said central section comprising at least two male and/or female tubular fittings extending axially on each side of the section.

In a preferred embodiment of the invention, the male and female fittings of the central section delimit together a diameter-change shoulder.

In a preferred embodiment of the invention, the column comprises at least one terminal column section configured to be mounted at the column tip, said column section comprising at least one male or female tubular fitting extending axially on only one side of the section and a terminal portion extending axially on the other side.

In a preferred embodiment of the invention, the terminal portion comprises a hooking and sealing member provided with notches and featuring, when viewed in section, a steeple shape for a tight hooking to an outer member.

In a preferred embodiment of the invention, the terminal portion comprises a frontal wall for sealing a fluid flow axial channel of the column.

In a preferred embodiment of the invention, the female and male fittings comprise mutual locking means in order to hold together the sections before assembly on the heat exchanger.

In a preferred embodiment of the invention, the mutual locking means comprise a lug and an axial guide receptacle of the lug to form a sliding axial connection with a predefined stroke length.

In a preferred embodiment of the invention, the lug has an inclined axial plane to facilitate an assembly by coupling of two sections with each other.

In a preferred embodiment of the invention, the fittings comprise rotation blocking means, involving for example an axial slot and a longitudinal rib.

In a preferred embodiment of the invention, each section comprises at least on one side a female and/or male pair of axial tubular fittings transversely superimposed on each other in order to form a double-column manifold.

In a preferred embodiment of the invention, the male fitting includes at least one peripheral groove for receiving at least one sealing element in a peripheral region for coupling with the consecutive female fitting.

In a preferred embodiment of the invention, the male fitting and the female fitting have a cross-section with an oblong general shape, the peripheral groove having, in turn, an oblong general shape for receiving at least one sealing element adapted to be deformed in an oblong manner.

In another preferred embodiment of the invention, the oblong general shape is substantially elliptical.

Advantageously, the male fitting delimits a fluid flow inner channel split into at least two sub-channels by a stiffening wall.

Another object of the invention is a battery-pack comprising a heat exchanger provided with a fluid circulation network terminating at least in a longitudinal row of inlet-outlet orifices and at least one manifold according to the invention to be assembled such that the orifices of the manifold coincide with the orifices of the exchanger.

### BRIEF DESCRIPTION OF THE DRAWINGS

Other features and advantages of the invention will come out in light of the following description, made with reference to the appended drawings in which:

FIG. 1 is a perspective view of a manifold according to the invention.

FIG. 2 is a perspective view of a central column section of the manifold of FIG. 1.

FIG. 3 is a sectional view of the column section of FIG. 2.

FIG. 4 is a perspective view of a half-section of the column section of FIG. 2.

FIG. 5 is a perspective view of a terminal column section of the manifold of FIG. 1.

FIG. 6 is a perspective view of another terminal column section of FIG. 1.

FIG. 7 is a perspective view of a double-column section of a manifold according to a second embodiment of the invention.

FIG. 8 is a perspective view of a heat exchanger of a battery-pack in which the manifold of FIG. 7 is mounted.

FIG. 9 is a perspective view of a central column section of a manifold according to a third embodiment of the invention.

FIG. 10 is a cut-away perspective view of the central column section of the manifold of FIG. 9.

FIG. 11 is a perspective view of a central double-column section of a manifold according to a fourth embodiment of the invention.

FIG. 12 is a cut-away perspective view of the central column section of the manifold according to a fourth embodiment of the invention.

### DESCRIPTION OF THE EMBODIMENTS

In FIG. 1, there is schematically represented a manifold according to a first embodiment of the invention. This manifold is referred to by the general reference numeral 10.

For example, this manifold 10 is intended to be mounted on a network of fluid circulation conduits of a battery-pack. For example, this network (not represented) has a row of tubing ends extending longitudinally onto which the manifold 10 can be mounted.

The manifold 10 comprises a column 12 provided according to a longitudinal axis with a plurality of fluid outlet orifices 20 spaced apart from each other by a variable or invariable step. In this example, the column 12 comprises a main body with a cylindrical general shape.

In accordance with the invention, this column 12 is removably mounted from a plurality of modular sections 14. As will be detailed hereinbelow, the column 12 comprises several configurations of modular sections 14.

In this first embodiment illustrated by FIG. 1, the column 12 comprises a plurality of central modular sections 14A and terminal modular sections which are mounted at the column tip and are distinctively referenced 14B and 14C. Thus, in this example, the terminal section referenced 14B serves as a manifold 10 inlet and the terminal section referenced 14C serves as a manifold 10 outlet and have distinct configuration to fill their respective functions.

It should be noted that, according to the invention, the expressions «axial» and the expression «axially», as used in the present description correspond to the longitudinal direction of the column 12. The terms «transverse», «transversely», «frontal», «frontally» concern a plane generally perpendicular to the column longitudinal extension. Finally, the term «radial» or «radially» refers to a direction perpendicular to the longitudinal main axis of the column 12.

In accordance with the invention, each column section 14 is provided with one single radial opening delimiting the outlet orifice 20. To this end, preferably, each modular section 14 comprises a radially-extending tubular connector body 22 which delimits a fluid flow passage 24 featuring a free end 26. This free end 26 delimits the fluid flow orifice, referenced 20, of the section 14.

In the described example, the connector body 22 is shaped into a portion of a quick-coupling connector 28 of the section with a complementary outer portion (not represented), for example belonging to the heat exchanger. Conventionally, a quick-coupling connector 28 includes a male portion and a female portion which are coupled to each other by simple introduction of one of them into the other.

In the described example, the connector body 22 comprises means 30 for locking the male portion in the female portion of the quick-coupling connector 28.

For example, the connector body 22 is provided with elastic coupling tabs 30 forming at least partially the locking means 30. Moreover, the connector body 22 is provided with at least one throat 32 for receiving a sealing O-ring gasket 34 in order to achieve sealing during quick fitting of the connector body 22 with the outer portion.

In accordance with the invention, each column section 14 is provided with at least one female tubular axial fitting 16 or with at least one male tubular axial fitting 18 for example for the terminal sections 14B or 14C or else with at least two female 16 and male 18 fittings each extending axially on each side of a central section 14A. In a variant of the invention which is not illustrated, a central section 14A may include two male 18 or female 16 identical fittings each extending axially on each side.

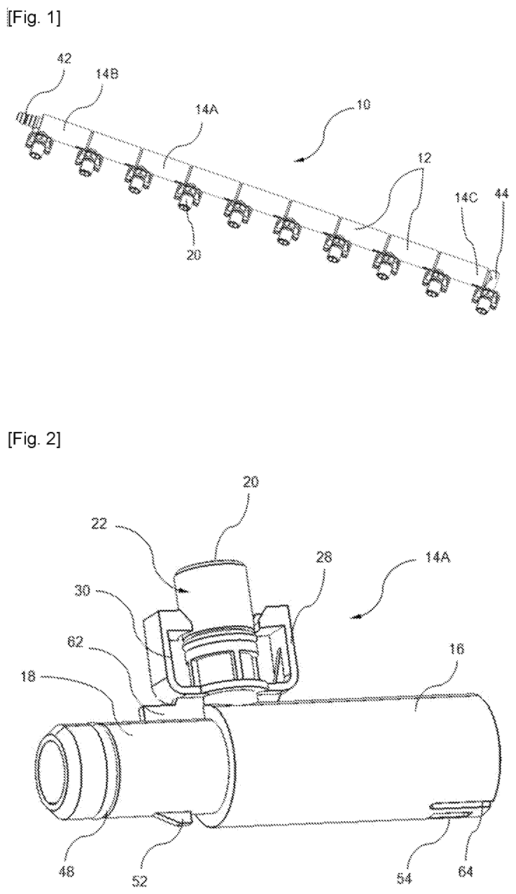

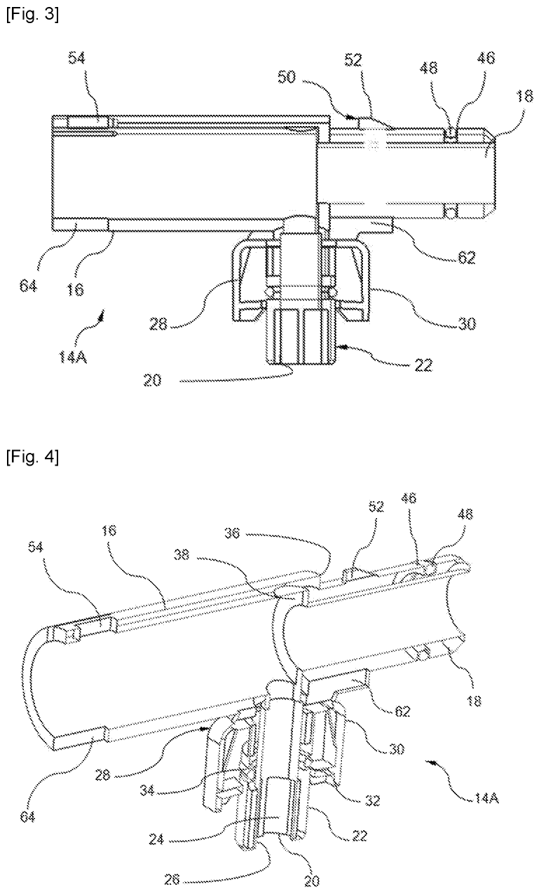

In FIGS. 2 to 4, there is represented in detail a central column section 14A. This central section 14A is configured to be connected to two other sections 14A, 14B and/or 14C. The central section 14A comprises at least two tubular fittings each extending axially on each side of the central section 14A.

In the example illustrated in these figures, the central section 14A comprises on a first side a male tubular fitting 18 and on the other side a female tubular fitting 16. In this example, the tubular fittings 16 and 18 are axially aligned. Alternatively, the tubular fittings 16 and 18 may extend axially in a «V» shape and more specifically according to a «Y» shaped configuration when considering the axes of the fittings 16 and 18 and of the flow orifice 20.

Preferably, the male 18 and female 16 fittings delimit together a diameter-change shoulder 36. This diameter change is visible from outside. Inside the section 14, there is also observed a narrowing 38 of the fluid passage section in the direction extending from the female fitting 16 to the male fitting 18.

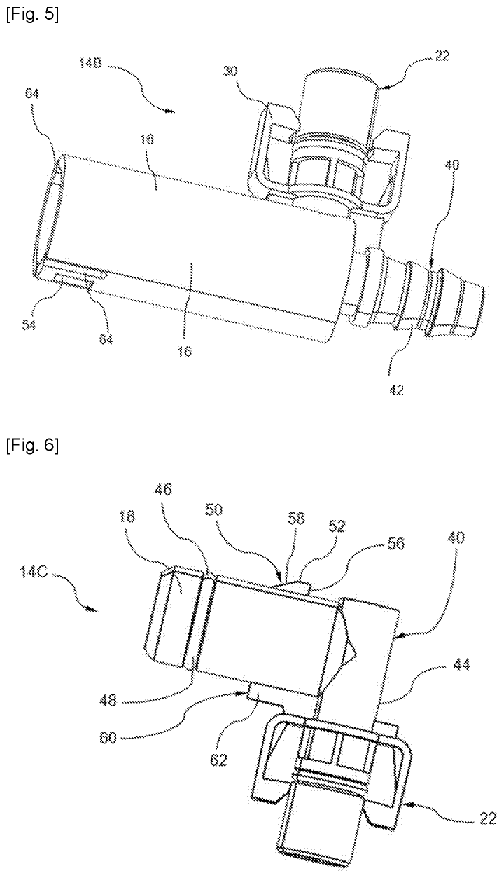

In FIG. 5, there is also represented a terminal column section 14B configured to be mounted at the column tip, said column section comprising at least one male 18 or female 16 tubular fitting extending axially on only one side of the section 14B and a terminal portion 40 extending axially on the other side. In the case of the section 14B of FIG. 5, the terminal portion 40 comprises a hooking and sealing member 42 provided with notches and featuring, when viewed in section, a steeple shape for a tight hooking to an outer member, for example a flexible hose. Any other shape known to those skilled in the art allowing achieving tightness with a conduit or a connector may also be considered for the hooking member 42. Moreover, in this example, the fitting of the terminal section 14B is a female fitting. This hooking member 42 extends from an extreme frontal face of the female fitting 16.

In FIG. 6, there is represented another configuration of the terminal section 14C. In this figure, the section 14C comprises on one side a male fitting 16 and on the other side a frontal wall 44 for sealing a fluid flow channel according to an axial direction. This frontal wall 44 may have a curvilinear shape in the continuation of the shape of the connector body 22.

Of course, all kinds of combinations of these configurations may be considered yet without departing from the scope of the present invention. Thus, the outlet terminal modular section 14C may include a female fitting 16 and the inlet terminal modular section 14B may include a male fitting 18.

More particularly, in accordance with the invention, the male tubular fitting 18 of a first section 14 is adapted to nest into and to slide in a tight manner inside the female tubular fitting 16 of a second section to enable a translational displacement of the sections 14 relative to each other in directions of extension and retraction of the column 12 in order to vary the spacing between two outlet orifices 20 of the column 12.

Preferably, the male fitting 18 includes in a peripheral region for coupling with a female fitting 16 a peripheral groove 46 for receiving a sealing gasket 48. Where appropriate, sealing may be reinforced by adding one or several peripheral groove(s) and, respectively, one or several sealing gasket(s).

Preferably, the male fitting 18 has a reduced outer diameter compared to the outer diameter of the female fitting 16. For example, the outer diameter of the male fitting 18 is substantially equal to the inner diameter of the female fitting 16.

In the described example, the female 16 and male 18 fittings comprise mutual locking means 50. This allows avoiding an unintentional separation of the sections 14 of the column 12 once these are mounted together.

Preferably, the mutual locking means 50 comprise sliding guide means according to a predefined translational stroke. Moreover, preferably, the male 18 and female 16 fittings also comprise means 60 for blocking the relative rotation of the two fittings 16 and 18.

In this example, the sliding guide means 50 include an axial guide lug 52 and a guide receptacle 54, for example a slot or possibly a groove, into which the lug 52 is received and guided in axial sliding.

In the example illustrated in particular in FIGS. 2 to 6, the male tubular fitting 18 is thus provided on its external circumferential surface with a radially-projecting portion forming the lug 52. Furthermore, the female tubular fitting 16 is pierced with an opening 54 with an oblong or rectangular general shape on its outer peripheral wall extending in the length direction according to a longitudinal direction forming the guide receptacle 54. In the described example, this opening 54 is located proximate to the free end of the female fitting 16.

The relative sliding stroke of the male fitting 18 inside the female fitting 16 is defined by the axial relative dimensions of the lug 52 and of its receptacle 54. Thus, at the end of the stroke, the lug 52 abuts against one of the axial ends of the guide slot 54 defining a mechanical end of the sliding stroke of the two fittings 16 and 18 into each other.

For example, as shown for example in detail in FIG. 6, the lug 52 comprises a radial wall 56 forming a stop and an inclined axial plane 58. This inclined axial plane 58 allows facilitating the elastic insertion of the lug 52 inside its receptacle 54. As illustrated in detail in FIG. 6, the lug 52 has an axial section with a trapezoidal general shape. Of course, other lug shapes may be suitable in the context of the present invention.

In order to block the relative rotation of the two fittings 16 and 18 resulting from a clearance that is likely existing in the sliding connection formed by the sliding guide means 50, there are also provided relative rotation blocking means 60. Preferably, these blocking means 60 are herein made by a connection involving a longitudinal slot and a radial projection. But of course, other configurations may be proposed yet without departing from the scope of the invention.

Thus, as illustrated in FIGS. 2 to 4, the male fitting 18 further comprises on its external circumferential surface a radially-projecting portion 62 in the form of a rib oriented in the longitudinal direction and intended to cooperate with a slit end 64 of the female fitting 16. The rib 62 extends from the diameter-change shoulder and is diametrically opposite to the sliding lug 52.

Thus, in FIG. 2, it is also shown that the female fitting 16 has two end slots 64 intended, in this example, to enable an elastic expansion of its peripheral wall and to facilitate its engagement around the male fitting 16. These expansion slots 64 are disposed in a diametrically-opposed manner, one of the expansion slots 64 being adjacent to the guide receptacle 54, the other one of the expansion slots 64 being used for the rotational blocking with the rib 62.

As shown in FIGS. 2 to 4, in the case of the central section 14A, the connector body 22 and the two tubular fittings 16 and 18 replicate a «T»-like general shape. It is also possible to consider shaping them in a «Y»-like shape. Moreover, the section 14C has an elbow-like general shape.

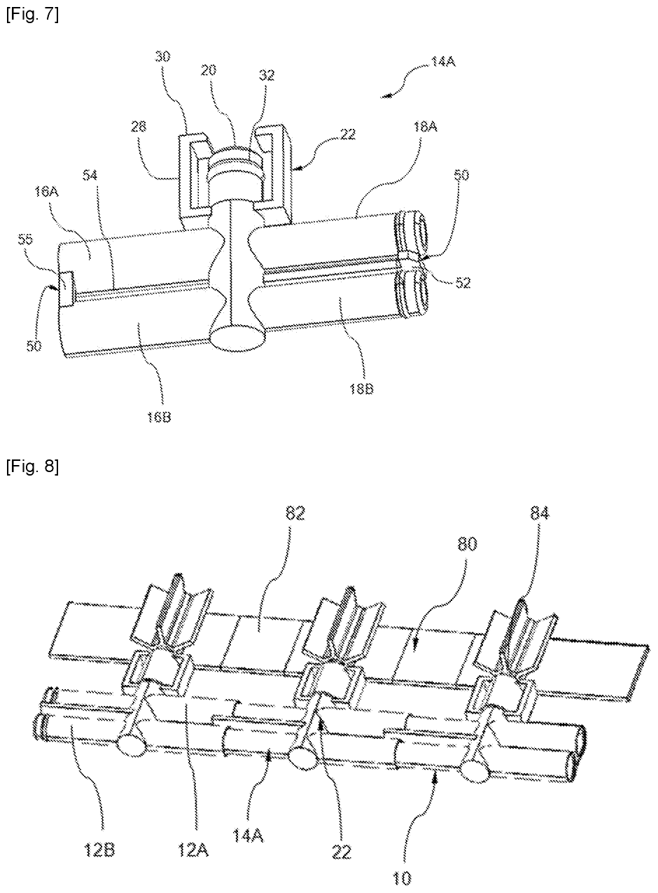

In FIG. 7, there is represented a column 12 central section 14A of a manifold according to a second embodiment of the invention. In this second embodiment, elements similar to those of the first embodiment bear the same reference numerals.

In this second embodiment, as illustrated in FIG. 7, each section 14A comprises at least on one side a pair of male 18A, 18B or female 16A, 16B identical axial tubular fittings transversely superimposed on each other in order to form a double-column 12A, 12B manifold 10.

The pair of male fittings 18A, 18B and the pair of female fittings 16A, 16B comprise mutual locking means 50. For example, the pair of male fittings 18A, 18B comprises a longitudinal area 70 for linking the two fittings of the pair terminating in a transversally-projecting portion forming a guide lug 52.

Furthermore, for example, the pair of female fittings 16A, 16B comprise a linking element 55 connecting the two fittings 16A, 16B of the extreme female pair and comprises a longitudinal interspace 54 existing between the two fittings 16A, 16B of the pair inside which the lug 52 of the pair of male fittings 18A, 18B can be axially guided.

In this second embodiment, the presence of a pair of fittings allows blocking the relative rotation of the consecutive sections relative to each other. Hence, it is not necessary to provide for additional rotation blocking means.

FIG. 8 illustrates an example of installation of a double-column 12A, 12B manifold 10 in a heat exchanger support 82 for a battery-pack 80. This heat exchanger 80 is provided with a fluid circulation network 84 terminating in at least one longitudinal row of orifices.

The double-column 12A, 12B manifold 10 is configured to be assembled such that the orifices of the manifold 10 coincide with the orifices of the exchanger 82.

Although not illustrated in this present description, those skilled in the art will easily deduce other configurations of column sections for this second embodiment, in particular column sections configured to be mounted at the column tip.

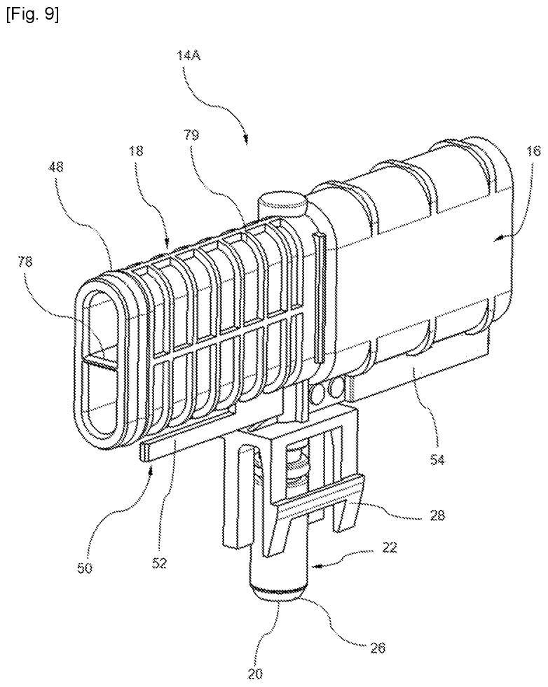

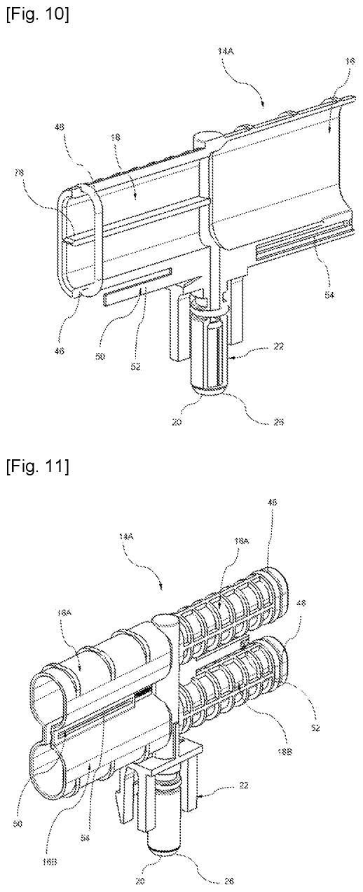

In FIGS. 9 and 10, there is represented a column 12 central section 14A of a manifold according to a third embodiment of the invention. In this third embodiment, elements similar to those of the first embodiment or of the second embodiment bear the same reference numerals.

Preferably, in this third embodiment, the male fitting 18 has a cross-section with an oblong general shape. The same applies to the female fitting 16 intended to cooperate with the male fitting. In the context of the present invention, the term «oblong» means a rounded shape which is rather long than wide. In this example, the peripheral groove 46 also has an oblong general shape for receiving a sealing gasket 48 adapted to be deformed according to an oblong general shape when mounted in the groove 46. Preferably, in one variant which is not illustrated, the oblong general shape is substantially elliptical.

In general, thanks to the particular arrangement of the section with an oblong general shape, this third embodiment has the advantage of limiting as much as possible pressure drops in the cooling circuit. In particular, in a non-limiting manner, this allows increasing the flow rate, limiting the dimensioning of a pump, improving the heat transfer or addressing any other functional or optimization requirement.

Such an arrangement turns out to be particularly suitable when the external environment of the part imposes a distribution of the dimensional constraints in one or several direction(s) while leaving empty space in other directions. It is then desirable, for optimizing the use of space, to stretch the channel in the directions that enable so and thus optimize the dimensions of the fluid passage section.

As example, the passage from a circular section with a diameter «D» to an oblong section composed by two half-circles with a diameter «D» connected to each other at the ends by junction segments with a length «L» enlarges the surface of the flow section by a product «L» by «D», and therefore multiplies the surface of the section by a non-negligible factor.

For example, the O-ring gasket 48 has a circular general shape, the latter being suited, through an appropriate dimensioning, to be mounted in the corresponding groove 46 with an oblong general shape, provided not to exceed a certain deformation limit.

In the case of channels with a very elongate oblong section requiring quite considerable deformations of the O-ring gasket 48, or to address specific technical constraints, it is possible to resort to a gasket with a shape which is, for example, non-circular and/or non-toric (lip seal, . . . )

The channel with a section that is circular, oblong or other, may also integrate a stiffening wall or inner longitudinal rib 78 which mechanically reinforces the channel as illustrated in FIGS. 9 and 10. Furthermore, the section 14 may preferably include circumferential or semi-circumferential stiffening ribs 79.

In one variant which is not illustrated, this inner rib 78 may also separate fluids. Thus, by disposing and by designing the inlets-outlets in a specific manner, it is possible to make two different fluids circulate in the same manifold, in the same direction or in opposite directions, or a supply circuit and a return circuit of the same fluid. This preferably applies to a double-column manifold, as described hereinafter in connection with the fourth embodiment, in which the columns may be fluidly separated or not.

Similarly, in the case of specific architectural constraints, it will also be possible to provide an asymmetrical device, both with regards to the geometry of the main flow channel(s) of the manifold and with regards to the inlet/outlet orifices.

Even though circular or oblong simple shapes are preferred, it is still possible to resort to other more complex shapes, in particular in the context of specific architectural constraints.

In this case, the connection seals between the different elements of the manifold are provided accordingly. The mutual locking means 50 may be disposed at the center between the two flow columns of the manifold, or be offset on either one of the sides of the manifold. Similarly, the system may embed two mutual locking means.

Preferably, the terminal modular sections that are mounted at the column tip and which are distinctively referenced 14B and 14C may also have a non-cylindrical geometry and may also have an oblong cross-section, to enlarge the passage section thereof. This passage enlargement may be made for both single-column manifolds and double-column manifolds.

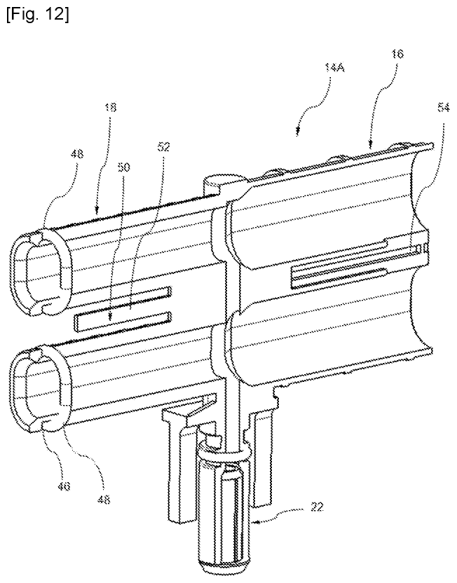

In FIGS. 11 and 12, there is represented a column 12 central section 14A of a manifold according to a fourth embodiment of the invention. In this fourth embodiment, elements that are similar to those of the second embodiment bear the same reference numerals.

In this fourth embodiment, as illustrated in FIG. 11, each section 14A comprises at least on one side a pair of male 18A, 18B or female 16A, 16B identical axial tubular fittings transversely superimposed on each other in order to form a double-column 12A, 12B manifold 10.

Preferably, as illustrated, each male or female tubular fitting has a cross-section with an oblong general shape.

The main aspects of a fluid inlet-outlet manifold according to the second embodiment illustrated by FIGS. 7 and 8 will now be described. Of course, this description also applies to the previously-described other embodiments.

Initially, the manifold 10 is in the form of detached parts with several central sections 14A and terminal sections 14B and 14C. The battery-pack 80 has a longitudinal row of inlet-outlet orifices. At a first step, the central sections 14A and the terminal sections 14B and 14C are assembled together thanks to the mutual locking means. The connectors 22 are spaced apart in an inaccurate manner. At a third step, the manifold 10 is set opposite the inlet-outlet orifices of the pack 80 and each section 14A is slid in a telescopic manner so as to make the connectors 22 coincide with the orifices of the pack 80 and achieve the assembly thereof by clipping or any other fastening means.

Of course, the invention is not limited to the previously-described embodiments. Other embodiments within the reach of those skilled in the art may also be considered yet without departing from the scope of the invention defined by the claims hereinafter.

1. A fluid inlet-outlet manifold comprising a column provided according to a longitudinal axis with a plurality of fluid flow orifices spaced apart from each other, wherein the column is removably mounted from a plurality of modular sections, each column section being provided with at least one female tubular axial fitting and/or with at least one male tubular axial fitting and featuring one single radial opening delimiting the flow orifice and in that a male tubular fitting is adapted to nest into and slide in a tight manner inside a consecutive female tubular fitting to enable a translational displacement of the sections relative to each other in directions of extension and retraction of the manifold in order to vary the spacing between two flow orifices.

2. The manifold according to claim 1, wherein the male fitting has a reduced external diameter compared to the external diameter of the female fitting.

3. The manifold according to claim 1, wherein the column section comprises a radially-extending tubular connector body which delimits a fluid flow passage featuring a free end forming the flow orifice.

4. The manifold according to claim 3, wherein the connector body forms a portion of a quick-coupling connector.

5. The manifold according to claim 1, wherein the column comprises at least one column section called central section configured to be connected to two other sections, said central section comprising at least two male and/or female tubular fittings extending axially on each side of the section.

6. The manifold according to claim 5, wherein the male and female fittings of the central section delimit together a diameter-change shoulder.

7. The manifold according to claim 1, wherein the column comprises at least one terminal column section configured to be mounted at the column tip, said column section comprising at least one male or female tubular fitting extending axially on only one side of the section and a terminal portion extending axially on the other side.

8. The manifold according to claim 7, wherein the terminal portion comprises a hooking and sealing member provided with notches and featuring, when viewed in section, a steeple shape for a tight hooking to an outer member.

9. The manifold according to claim 5, wherein the terminal portion comprises a frontal wall for sealing a fluid flow axial channel of the column.

10. The manifold according to claim 1, wherein the female and male fittings comprise mutual locking means.

11. The manifold according to claim 1, wherein the mutual locking means comprise a lug and an axial guide receptacle of the lug to form a sliding axial connection with a predefined stroke length.

12. The manifold according to claim 9, wherein the lug has an inclined axial plane to facilitate an assembly by coupling of two sections

13. The manifold according to claim 1, wherein the fittings comprise rotation blocking means, involving for example an axial slot and a longitudinal rib.

14. The manifold according to claim 1, wherein each section comprises at least on one side a female and/or male pair of axial tubular fittings transversely superimposed on each other in order to form a double-column manifold.

15. The manifold according to claim 1, wherein the male fitting includes at least one peripheral groove for receiving at least one sealing element in a peripheral region for coupling with the consecutive female fitting.

16. The manifold according to claim 15, wherein the male fitting and the female fitting have a cross-section with an oblong general shape, the peripheral groove having, in turn, an oblong general shape for receiving at least one sealing element adapted to be deformed in an oblong manner.

17. The manifold according to claim 16, wherein the oblong general shape is substantially elliptical.

18. The manifold according to claim 1, wherein the male fitting delimits a fluid flow inner channel split into at least two sub-channels by a stiffening wall.

19. A battery-pack comprising a heat exchanger provided with a fluid circulation network terminating at least in a longitudinal row of inlet-outlet orifices and at least one manifold according to claim 1 configured to be assembled such that the orifices of the manifold coincide with the orifices of the exchanger.
